(19) United States
(12) Patent Application Publication
(10) Pub. No.: US 2010/0252259 A1
(43) Pub. Date: Oct. 7, 2010

(54) OIL-BASED HYDRAULIC FRACTURING FLUIDS AND BREAKERS AND METHODS OF PREPARATION AND USE

(76) Inventor: Robert L. Horton, Sugar Land, TX (US)

Correspondence Address: GORDON G. WAGGETT, P.C., 550 WESTCOTT STREET, SUITE 350, HOUSTON, TX, 77007-5099, US

(21) Appl. No.: 12/752,104

(22) Filed: Mar. 31, 2010

Related U.S. Application Data
(63) Continuation-in-part of application No. 12/728,516, filed on Mar. 22, 2010.
(60) Provisional application No. 61/211,582, filed on Apr. 1, 2009.
(60) Provisional application No. 61/211,859, filed on Apr. 2, 2009.

(51) Int. Cl. E21B 43/26; C09K 8/32

(52) U.S. Cl. 166/271; 507/241

(57) ABSTRACT

A hydraulic fracturing fluid includes a hydrocarbon fluid and viscosifying agent, wherein the viscosified fluid is a Newtonian fluid; a hydrocarbon fluid and gelling agent, wherein the viscosified fluid is a power law fluid; a hydrocarbon fluid, a gelling agent, and a rheological additive, wherein the viscosified fluid is a yield power law fluid; or a hydrocarbon fluid, a gelling agent, a rheological additive, and solvent for the rheological additive, wherein the viscosified fluid is a yield power law fluid. The hydrocarbon fluid is preferably weighted with nano-scale or self suspending weighting agents. The hydraulic fracturing fluids are prepared for use in fracturing a subterranean petroliferous formation. A weighted (preferably with nano-scale weighting agent), oil-based hydraulic fracture fluid breaker is also disclosed. A method is disclosed for subsequently recovering a substantial fraction of the fracturing fluid conventionally or by applying a viscosity breaker and recovering the viscosity-broken fracturing fluid conventionally.

### CROSS-REFERENCE TO RELATED APPLICATIONS

This application claims the benefit of the filing date of and priority to the following: U.S. Nonprovisional application Ser. No. 12/728,516 entitled “Miscible stimulation and flooding of petroliferous formations utilizing viscosified oil-based fluids” and filed Mar. 22, 2010, Confirmation No. 5521 (as a continuation-in-part); U.S. Provisional Application Ser. No. 61/211,582 entitled “Oil-based hydraulic fracturing fluids” and filed Apr. 1, 2009, Confirmation No. 7528; and U.S. Provisional Application Ser. No. 61/211,859 entitled “Oil-based hydraulic fracturing fluids” and filed Apr. 2, 2009, Confirmation No. 5507. Said applications are incorporated by reference herein.

### STATEMENT REGARDING FEDERALLY SPONSORED RESEARCH OR DEVELOPMENT

Not Applicable.

### BACKGROUND OF THE INVENTION

1. Field of the Invention

The invention relates generally to oil-based hydraulic fracturing fluids. More specifically, the invention relates to weighted, oil-based hydraulic fracturing fluids. Yet more specifically, the invention relates to weighted, oil-based hydraulic fracturing fluids optionally wherein the fluids comprise nano-scale particles or otherwise self-suspending particles and to weighted, oil-based fluids optionally which can act as breakers for conventional hydraulic fracturing fluids as well as for those wherein the hydraulic fracturing fluids comprise nano-scale particles.

2. Background Art

As recognized by the present inventor in Leggett et al., U.S. Patent Application Serial No. US2007149412 (published Jun. 28, 2007 and naming the present inventor as a coinventor), but to meet altogether different performance objectives, a variety of fluids, such as packer fluids and hydraulic fracturing fluids, have been developed in the past which incidentally also possess miscibility with or multiple-contact-miscibility with a wide range of oils, heavy oils, gas condensates, and/or gases in place in largely horizontally disposed subterranean petroliferous formations but which fluids developed in the past also happen to be substantially lower in mobility than said oil, heavy oil, gas condensate, or gas in place. Leggett et al. is incorporated herein by reference even though the present disclosure improves upon Leggett et al. Hyde et al., U.S. Pat. No. 3,613,792 describes simple fluids which may be used as the injectant medium. Brandt et al., U.S. Pat. No. 4,258,791 improves on these injectant materials by disclosing an oleaginous liquid such as topped crude oils, gas oils, kerosene, diesel fluids, heavy alkylates, fractions of heavy alkylates, and the like in combination with an aqueous phase, lime, and a polymeric material. House et al., U.S. Pat. No. 4,528,104 teaches a fluid comprised of an oleaginous liquid such as diesel oil, kerosene, fuel oil, lubricating oil fractions, heavy naphtha and the like in combination with an organophillic clay gellant and a clay dispersant such as a polar organic compound and a polyfunctional amino-silane.

Leggett et al. discloses a packer or annular fluid that includes a hydrocarbon fluid; and a gelling agent; wherein the packer fluid is a yield power law fluid. A method for preparing a packer fluid includes preparing a mixture of a hydrocarbon fluid, and a gelling agent; heating the mixture to a selected temperature; and shearing the mixture. A method for emplacing a packer fluid into an annulus includes preparing the packer fluid that includes a hydrocarbon fluid and a gelling agent, wherein the packer fluid is a yield power law fluid; and pumping the packer fluid into the annulus.

As also recognized by the present inventor in Leggett et al., gelled hydrocarbons have been successfully used as hydraulic fracturing fluids and viscosified fluids because the gel formation suitably increases the viscosities of the fluids. As further recognized by the present inventor in Leggett et al., polyvalent metal (typically, ferric iron or aluminum or the chelated forms of ferric iron or aluminum) salts of phosphoric acid esters have been successfully used as gelling agents for forming high viscosity gelled hydrocarbon fluids. Description of these fluids and their uses can be found in U.S. Pat. Nos. 4,507,213 issued to Daccord et al., 4,622,155 issued to Harris et al., 5,190,675 issued to Gross, and 5,846,915 issued to Smith et al. More recently, U.S. Pat. No. 6,511,944 issued to Taylor et al. discloses gelled hydrocarbon hydraulic fracturing fluids that include ferric iron or aluminum polyvalent metal salts of phosphonic acid esters, instead of phosphoric acid esters. Unfortunately, these gelled hydrocarbon fracture fluids are Newtonian or power law fluids having densities that are comparable to the density of the base fluid. These patents are hereby incorporated herein by reference even though the present invention improves upon them, among other ways, by teaching how to make the fluids into power law and yield power law fluids, i.e., those that exhibit τ_{y}═0 and τ_{y}≠0, having densities that are greater than the density of the base hydrocarbon fluid.

In published U.S. Patent Application 2008274041, (Nov. 6, 2008), entitled, “Preparation of Nanoparticle-Size Zinc Compounds”, Hughes et al., teach a method for making a dispersion of metal oxide particles in hydrocarbon. A metal-containing compound that thermally disintegrates is dispersed in a hydrocarbon solvent with a selected organic acid and the mixture is heated to a temperature range to cause the metal-containing compound to thermally disintegrate into nano-sized particles. However, Hughes et al., teach nothing as to using such dispersions of metal oxide particles as hydrocarbon-based hydraulic fracturing fluids.

In U.S. Pat. No. 7,185,663, (Mar. 6, 2007), entitled, “Methods and Compositions for On-line Gas Turbine Cleaning” Koch et al., teach methods and compositions for on-line cleaning of internal surfaces of selected sections of a gas turbine and associated heat recovery equipment, during operation. Cleaning solutions containing graphite and/or metal-based particles and oil soluble corrosion inhibitors, aromatic solvents, and surfactants are selectively introduced directly into the combustion chamber (combustor) of the gas turbine, into the fuel stream, water washing system, or the combustion air system (hot gas path). The cleaning process dislodges unwanted ash deposit buildup and, thereby restores the gas turbine to rated power. When introduced into the compressor section, the particles impinge on the metal surfaces, cleaning them prior to entering the hot gas section where the process may be repeated. They may also be carried through the exhaust to additionally clean attendant heat recovery equipment, if present.

Additionally, besides relatively low density, as recognized by the present inventor in Leggett et al., another short-coming of the above-referenced hydraulic fracturing fluids has been their limited stability—after all, they need only last a matter of hours, since even a massive hydraulic fracturing job involving 2,000,000 pounds of proppant is typically concluded in less than 8 hours. Although these fluids have worked well in the hydraulic fracturing applications in the past, Leggett et al. describes that there is still a need for insulating annular or packer-fluids that are stable for extended periods, low in thermal conductivity, and simultaneously inhibitive of convective heat loss. In the present invention, there is still a need for hydraulic fracturing fluids for applications at higher temperatures and for longer durations that are stable for extended periods at high temperatures and simultaneously are substantially more dense that their base fluids, permitting the hydraulic fracturing fluids to suspend denser and more concentrated loadings of proppants without having the proppant screen out at or near the entrance to the fracture.

It is known to those skilled in the art of magnesium additives (see, e.g., U.S. Pat. Nos. 3,150,089 (Hunt) and 4,056,479 (Redmore et al.)) that overbased formulations having small particle sizes can perform at lower concentrations.

The formation of magnesium oxide (MgO) through thermal degradation of magnesium hydroxide (Mg(OH)₂) is well known (e.g., Cheng et al., U.S. Pat. No. 4,163,728). During the Cheng process, Mg(OH)₂ is “explosively” degraded into MgO and H₂O to form an overbased dispersion of MgO. Magnesium carboxylates—i.e., magnesium salts of carboxylic acids—can also be used in similar fashion to produce MgO particles.

### SUMMARY OF INVENTION

In one aspect, the present invention relates to hydraulic fracturing fluids. A hydraulic fracturing fluid in accordance with one embodiment of the invention includes a hydrocarbon fluid, a weighting agent that may optionally be a self suspending weighting agent, and a gelling agent wherein the hydraulic fracturing fluid is a Newtonian, power law, or yield power law fluid.

In another aspect, the present invention relates to a hydraulic fracturing fluid that includes a hydrocarbon fluid, a weighting agent that may optionally be a self-suspending weighting agent, a gelling agent, and a rheological additive, wherein the hydraulic fracturing fluid is a Newtonian, power law, or yield power law fluid.

In another aspect, the present invention relates to methods for preparing a hydraulic fracturing fluid. A method in accordance with one embodiment of the invention includes preparing a mixture of a hydrocarbon fluid, a weighting agent that may optionally be a self-suspending weighting agent, a gelling agent, and a rheological additive; heating the mixture to a selected temperature; and shearing the mixture. In yet another aspect, a method in accordance with one embodiment of the invention includes preparing a mixture of a hydrocarbon fluid, a weighting agent that may optionally be a self-suspending weighting agent, and a gelling agent; optionally heating the mixture to a selected temperature or not; and optionally shearing the mixture or not.

In another aspect, the present invention relates to methods for emplacing a hydraulic fracturing fluid into a wellbore and optionally the vicinity thereof. A method in accordance with one embodiment of the invention includes preparing the annular fluid that includes a hydrocarbon fluid, a weighting agent that may optionally be a self-suspending weighting agent, a gelling agent, and a rheological additive, wherein the hydraulic fracturing fluid is a Newtonian, power law, or yield power law fluid; and pumping the hydraulic fracturing fluid into a wellbore and optionally the vicinity thereof, such as, for example, in the fractures extending from said wellbore.

The present invention is directed to a method for injecting a hydraulic fracturing fluid into a subterranean petroliferous formation and includes preparing the hydraulic fracturing fluid that includes (a) a hydrocarbon fluid or weighted hydrocarbon fluid and a viscosifying agent, wherein the viscosified fluid is a Newtonian fluid, (b) a hydrocarbon fluid or weighted hydrocarbon fluid and a gelling agent, wherein the viscosified fluid is a power law fluid, (c) a hydrocarbon fluid or weighted hydrocarbon fluid, a gelling agent, and a rheological additive, wherein the viscosified fluid is a yield power law fluid, or (d) a hydrocarbon fluid or weighted hydrocarbon fluid, a gelling agent, a rheological additive, and a solvent for the rheological additive, wherein the viscosified fluid is a yield power law fluid; and pumping the hydraulic fracturing fluid into the subterranean petroliferous formation in order to create a hydraulic fracture. A method is also provided in the present invention for subsequently recovering, from the proppant and from the proppant pack left behind in the fracture, a substantial fraction of the hydraulic fracturing fluid conventionally or by applying a viscosity breaker and recovering the viscosity-broken hydraulic fracturing fluid conventionally is also disclosed along with the exemplary hydraulic fracturing fluids and the methods of making these fluids.

In one embodiment of the present invention there is disclosed a hydraulic fracturing fluid comprising a weighted hydrocarbon fluid and a viscosifying agent. In another embodiment of the present invention there is disclosed a hydraulic fracturing fluid comprising a weighted hydrocarbon fluid and a gelling agent. In yet another embodiment of the present invention there is disclosed a hydraulic fracturing fluid comprising a weighted hydrocarbon fluid, a gelling agent and a rheological additive. The hydrocarbon fluid may comprise at least one selected from diesel, a mixture of diesels and paraffin oil, mineral oil, and isomerized olefins. The weighted hydraulic fracturing fluids of the present invention are designed to exhibit the fluid characteristics or properties of power law fluids, yield power law fluids, Newtonian fluids or Bingham-plastic fluids. In one embodiment, the weighted hydrocarbon fluid comprises a nano-scale dispersion of a weighting agent comprising at least one of barium sulfate, barium carbonate, zinc oxide, zinc nitride, magnesium oxide, or iron oxide, in a hydrocarbon-based fluid. In another embodiment, the weighted hydrocarbon fluid comprises a nano-scale-zinc-oxide dispersed in a hydrocarbon-based fluid. The gelling agent may comprise a multivalent metal ion and at least one ester selected from the group consisting of a phosphoric acid ester and a phosphonic acid ester. In one embodiment, the multivalent metal ion is at least one selected from the group consisting of a ferric ion, an aluminum ion, a chelated ferric ion and a chelated aluminum ion. The rheological additive may an alkyl diamide having a formula: R₁—HN—CO—(CH₂)ₙ—CO—NH—R₂, wherein n is an integer from 1 to 20, R₁ is an alkyl groups having from 1 to 20 carbons, and R₂ is hydrogen or an alkyl group having from 1 to 20 carbons. In one embodiment, the rheological additive is present at a concentration of 3-13 pounds per barrel.

There is also disclosed a method for preparing a hydraulic fracturing fluid as described herein, comprising the steps of preparing a mixture of a hydrocarbon fluid (such as that described herein) and a viscosifying agent; optionally heating the mixture to a selected temperature or not; and optionally mixing or shearing the mixture. Another method for preparing a viscosified fluid (as described herein) comprises the steps of preparing a mixture of a desired hydrocarbon fluid and a desired gelling agent (such as those described herein); optionally heating the mixture to a selected temperature or not; and optionally mixing or shearing the mixture. Yet another method for preparing a hydraulic fracturing fluid comprises the steps of preparing a mixture of a desired hydrocarbon fluid (as described herein), a desired gelling agent (e.g., as described herein), and a desired rheological additive (as described herein); heating the mixture to a selected temperature; and shearing the mixture. Another method for preparing a viscosified fluid comprises the steps of preparing a mixture of a desired hydrocarbon fluid and a desired rheological additive, as described herein; heating the mixture to a selected temperature; shearing the mixture; and adding in a desired gelling agent. In another method for preparing a viscosified fluid, the steps comprise preparing a mixture of a desired hydrocarbon fluid, a desired gelling agent, a desired rheological additive, and a solvent for the rheological additive; heating the mixture to a selected temperature; and shearing the mixture. Another method disclosed for preparing a viscosified fluid comprises the steps of preparing a mixture of a hydrocarbon fluid, a rheological additive, and a solvent for said rheological additive; heating the mixture to a selected temperature; shearing the mixture; and adding in a gelling agent.

There is also disclosed a method for injecting a hydraulic fracturing fluid into a subterranean petroliferous formation, comprising the steps of preparing the desired hydraulic fracturing fluid as described herein (designed to exhibit the fluid characteristics or properties of power law fluids, yield power law fluids, Newtonian fluids or Bingham-plastic fluids) and pumping the hydraulic fracturing fluid into the subterranean petroliferous formation to achieve the hydraulic fracturing. In one embodiment of this method, the hydraulic fracturing fluid comprises a hydrocarbon fluid and a viscosifying agent and is a Newtonian fluid. In another embodiment of this method, the hydraulic fracturing fluid comprises a weighted hydrocarbon fluid (as described herein) and a viscosifying agent and is a Newtonian fluid. In yet another embodiment of this method, the hydraulic fracturing fluid comprises a hydrocarbon fluid and a gelling agent and is a power law fluid. In another embodiment of this method, the hydraulic fracturing fluid comprises a weighted hydrocarbon fluid (as described herein) and a gelling agent and is a power law fluid. In yet another embodiment of this method, the hydraulic fracturing fluid comprises a hydrocarbon fluid, a gelling agent, and a rheological additive (and optionally, the addition of a solvent for the rheological additive) and is a yield power law fluid. In yet another embodiment of this method, the hydraulic fracturing fluid comprises a weighted hydrocarbon fluid (as described herein), a gelling agent, and a rheological additive (and optionally, the addition of a solvent for the rheological additive) and is a yield power law fluid. These methods may further comprise the step of subsequently recovering some (preferably a substantial fraction) of the hydraulic fracturing fluid by applying a viscosity breaker proximate the hydraulic fracturing fluid in the subterranean petroliferous formation and then flowing the viscosity-broken fluid back to the surface. Additionally, these methods of injection may be preceded, if desired, by the initial step of determining whether alkalinity conditions exist in the petroliferous formation that could be damaging to the hydraulic fracturing fluid, and if so, prior to the injection of the hydraulic fracturing fluid, injecting a mild acid or acid gas to neutralize the alkalinity.

Also disclosed is a hydraulic fracturing fluid for injection into a subterranean petroliferous formation comprising: a weighted hydrocarbon-based fluid comprising a nano-scale weighting agent dispersed in a hydrocarbon-based fluid, and at least one additive selected from the group consisting of viscosifying agents, gelling agents and rheological agents, wherein the hydraulic fracturing fluid has fluid behavior characteristics selected from the group consisting of yield power law fluids, power law fluids, Bingham-plastic fluids and Newtonian fluids. The nano-scale weighting agent may comprise at least one of barium sulfate, barium carbonate, zinc oxide, zinc nitride, magnesium oxide, or iron oxide. The nano-scale weighting agent may comprise a nano-scale-zinc-oxide. The gelling agent may comprise a multivalent metal ion and at least one ester selected from the group consisting of a phosphoric acid ester and a phosphonic acid ester. In one embodiment, the multivalent metal ion is at least one selected from the group consisting of a ferric ion, an aluminum ion, a chelated ferric ion and a chelated aluminum ion. The rheological agent may be an alkyl diamide having a formula: R₁—HN—CO —(CH₂)ₙ—CO—NH—R₂, wherein n is an integer from 1 to 20, R₁ is an alkyl groups having from 1 to 20 carbons, and R₂ is hydrogen or an alkyl group having from 1 to 20 carbons. In one embodiment, the rheological agent is present at a concentration of 3-13 pounds per barrel. The rheological agent may also be used with a solvent for the rheological agent. The hydrocarbon-based fluid can comprise at least one selected from diesel, a mixture of diesels and paraffin oil, mineral oil, and isomerized olefins. In one embodiment, the additive comprises a viscosifying agent. In one embodiment, the additive comprises a gelling agent. In one embodiment, the additive comprises a gelling agent and a rheological agent. In one embodiment, the additive comprises a gelling agent, a rheological agent and a solvent for the rheological agent.

There is also disclosed a method for preparing a hydraulic fracturing fluid for injection into a subterranean petroliferous formation comprising the steps of: preparing a mixture of a weighted hydrocarbon-based fluid comprising a nano-scale weighting agent dispersed in a hydrocarbon-based fluid and at least one additive selected from the group consisting of viscosifying agents, gelling agents and rheological agents; optionally heating the mixture to a selected temperature; and optionally shearing the mixture, wherein the mixture has fluid behavior characteristics selected from the group consisting of yield power law fluids, power law fluids, Bingham-plastic fluids and Newtonian fluids.

Additionally, there is disclosed a method for hydraulic fracturing a subterranean petroliferous formation comprising the steps of: preparing a hydraulic fracturing fluid comprising: a mixture of (a) a weighted hydrocarbon-based fluid comprising a nano-scale weighting agent dispersed in said hydrocarbon-based fluid, and (b) at least one additive selected from the group consisting of viscosifying agents, gelling agents and rheological agents; and pumping said fluid mixture (with or without proppant) from the surface into said subterranean petroliferous formation; wherein said hydraulic fracturing fluid exhibits fluid behavior characteristics selected from the group consisting of yield power law fluid characteristics, power law fluid characteristics, Bingham-plastic fluid characteristics, and Newtonian fluid characteristics. In one embodiment of this method, the nano-scale weighting agent comprises at least one of barium sulfate, barium carbonate, zinc oxide, zinc nitride, magnesium oxide, or iron oxide. In another embodiment, the nano-scale weighting agent comprises a nano-scale-zinc-oxide. The gelling agent may comprise a multivalent metal ion and at least one ester selected from the group consisting of a phosphoric acid ester and a phosphonic acid ester. In one embodiment, the multivalent metal ion is at least one selected from the group consisting of a ferric ion, an aluminum ion, a chelated ferric ion and a chelated aluminum ion. The rheological additive used in this method may be an alkyl diamide having a formula: R₁—HN—CO—(CH₂)ₙ—CO—NH—R₂, wherein n is an integer from 1 to 20, R₁ is an alkyl groups having from 1 to 20 carbons, and R₂ is hydrogen or an alkyl group having from 1 to 20 carbons. The rheological additive in one embodiment is present at a concentration of 3-13 pounds per barrel. A solvent can be employed for the rheological agent.

In the practice of this method, the hydrocarbon fluid may comprise at least one selected from diesel, a mixture of diesels and paraffin oil, mineral oil, and isomerized olefins. In one embodiment of this method, the additive comprises a viscosifying agent. In another embodiment of this method, the additive comprises a gelling agent. In yet another embodiment of this method, the additive comprises a gelling agent and a rheological agent. In a further embodiment of this method, the additive comprises a gelling agent, a rheological agent and a solvent for the rheological agent. The method may further comprise the step of subsequently recovering some (but preferably a substantial fraction) of the hydraulic fracturing fluid back to the surface from the subterranean petroliferous formation. The method may further comprise the step of subsequently recovering some of the hydraulic fracturing fluid by first applying a viscosity breaker proximate to the viscosified miscible enhanced oil recovery fluid in the subterranean petroliferous formation and then flowing some (but preferably a substantial fraction) of the viscosity-broken fluid back to the surface. The method may further comprise the initial step of determining whether alkalinity conditions exist in the petroliferous formation that could be damaging to the viscosified miscible enhanced oil recovery fluid, and if so, prior to the injection of the miscible viscosified enhanced oil recovery fluid, a mild acid or acid gas is injected to neutralize the alkalinity.

Another embodiment of the present disclosure includes oil-based breaker fluid comprising a weighted hydrocarbon-based fluid comprising a weighting agent dispersed in a hydrocarbon-based fluid, wherein said breaker fluid has fluid behavior characteristics selected from the group consisting of yield power law fluids, power law fluids, Bingham-plastic fluids and Newtonian fluids. In one embodiment, the weighting agent comprises nano-scale particles or self-suspending particles. In another embodiment, the nano-scale weighting agent comprises a nano-scale-zinc-oxide. The nano-scale particles or self-suspending particles cane be selected from the group consisting of alkali metals, alkaline earth metal salts, and transition metal salts. The nano-scale particles or self-suspending particles can also be selected from the group consisting of barium sulfate, barium carbonate, zinc oxide, zinc nitride, magnesium oxide, or iron oxide. In another embodiment, the breaker fluid optionally further comprises at least one additive selected from the group consisting of viscosifying agents, gelling agents and rheological agents (such as, for example, those described herein).

Another embodiment of the present disclosure includes an oil-based breaker fluid comprising: a weighted hydrocarbon-based fluid comprising a weighting agent dispersed in a hydrocarbon-based fluid, and at least one additive selected from the group consisting of viscosifying agents, gelling agents and rheological agents (such as, for example, those described herein), wherein the breaker fluid has fluid behavior characteristics selected from the group consisting of yield power law fluids, power law fluids, Bingham-plastic fluids and Newtonian fluids. In one embodiment, the weighting agent comprises nano-scale particles or self-suspending particles. In another embodiment, the nano-scale weighting agent comprises a nano-scale-zinc-oxide. The nano-scale particles or self-suspending particles can be alkali metals, or alkaline earth metal salts, or transition metal salts. The nano-scale particles or self-suspending particles can also be selected from the group consisting of barium sulfate, barium carbonate, zinc oxide, zinc nitride, magnesium oxide, or iron oxide.

Other aspects and advantages of the invention will be apparent from the following description and the appended claims.

### DETAILED DESCRIPTION OF INVENTION

Embodiments of the present disclosure relate to hydraulic fracturing fluids and methods of preparing and emplacing such fluids. Hydraulic fracturing fluids according to the present disclosure have good long-term thermal stability properties, densities greater than those of their base fluids, and unique rheological properties.

The purpose of hydraulic fracturing is to provide a wellbore accessing a petroliferous subterranean formation greater productivity by creating a large-surface-area fracture therein and propping the fracture open with a coarse material (often called a proppant) that will mechanically prevent the fracture from subsequently closing. Accordingly, one of the roles of a hydraulic fracturing fluid is to serve as a transmitter of hydraulic horsepower applied from the surface to the rock-face in order to create and propagate said fracture and then another role of a hydraulic fracturing fluid is to serve as a carrier to suspend said proppant and transport it down the wellbore and out into the fracture. These roles dictate the rheological and performance properties that are required of a hydraulic fracturing fluid. Because fractures virtually always start closing once the hydraulic pressure bearing upon them is reduced, the inclusion of a proppant along with a hydraulic fracturing fluid is almost always the standard practice in a hydraulic fracturing operation. However, the initial stages of a hydraulic fracturing operation often include what some have termed a “data frac” in which the hydraulic pressure is expressed via a proppant-free hydraulic fracturing fluid in order to record data concerning the mechanical properties of the subterranean petroliferous formation. So it cannot be said that a hydraulic fracturing fluid is never deployed without having a proppant also deployed therein. Nevertheless, it should also be noted that it would be very rare for a “data-frac” to be done and then not follow up fairly quickly thereon with a deployment of the same hydraulic fracturing fluid with proppant.

One embodiment in accordance with the present invention is to use novel hydraulic fracturing fluids, as described herein, to inject (with or without a suitable proppant) into a subterranean petroliferous formation—an oil, heavy oil, gas condensate, or gas field or a field comprising a mixture of these, for purposes of hydraulically fracturing the formation.

The present invention also pertains to a novel nano-scale-zinc-oxide dispersed in a hydrocarbon-based fluid available from Liquid Minerals Group, Inc. (New Waverly, Tex.) to create a weighted hydrocarbon-based fluid. Alternative weighting agents for such nano-scale dispersed weighted hydrocarbon-based fluids runs the usual gamut of weighting agents for drilling fluids—weighting agents such as, for example, barium sulfate, barium carbonate, zinc oxide, zinc nitride, magnesium oxide, iron oxide, and mixtures thereof. These weighting agents can be prepared using nanotechnology and blended into a hydrocarbon-based fluid to create a nano-scale dispersed weighted fluid. This fluid can be blended with hydrocarbon-based injectant fluids to achieve a Newtonian fluid of any density between that of the ordinary hydrocarbon- or oil-based fluid (˜5 to ˜7.2 lbₘ/gal) and the hydrocarbon-based fluid involving the dispersed nano-scale zinc oxide (˜11.5 lbₘ/gal). If the largely horizontally configured subterranean petroliferous formation has even the slightest deviation from horizontal, then a denser (˜9 to ˜11 lbₘ/gal) injectant can be injected low in the formation on the end of the reservoir toward the lower end and the injectant will tend to remain in the lower reaches of the formation in relationship to the less dense (˜5 to ˜9 lbₘ/gal) original oil, heavy oil, gas condensate, or gas in place, permitting the latter to be produced from a well or wells completed in the upper reaches of the upper end of the reservoir.

Another embodiment in accordance with the present invention begins much as the hydraulic fracturing embodiment in accordance with the present invention but at the end of the fracturing operation, subsequent steps are performed by novel means—such as, for example, employing a viscosity breaker to the hydraulic fracturing fluid—or by means already well known to those skilled in the art—such as, for example, employing a gas or steam stimulation, gas flood, steam flood, or waterflood—so that the larger part of the hydraulic fracturing fluid may also be recovered from the formation.

The teachings of Leggett et al. focus on the use of yield power fluids (non-Newtonian fluids) as packer fluids, and provide that for an insulating annular fluid, rheological behavior is needed that is different from the power law, in other words, for these insulating annular fluids, what is needed is yield power behavior. Additionally, the teachings of Leggett et al. would provide against the use of any weighted fluid inasmuch as while the weighting agent remained dispersed throughout the fluid, it would increase the thermal conductivity (exactly what Leggett et al. was trying to avoid) and inasmuch as conventional weighting agents are only micronized or even coarser and, as such, cannot be maintained in dispersion for extended periods like 5 years or 40 years. In contrast, with the present invention, the weighting agents are nano-scale, therefore they remain dispersed indefinitely through the action of Brownian motion and the increased thermal conductivity is not a detriment. As such, the hydraulic fracturing fluids of the present invention can utilize these nano-scale weighting agents to advantage in yield power law fluids (such as those described in Leggett et al.), power law fluids, Bingham-plastic fluids, and Newtonian fluids.

Creating a weighted hydraulic fracturing fluid of the present invention can begin with a base fluid containing these nano-scale weighting agents and the base fluid can subsequently be converted to yield power law fluids, power law fluids, Bingham-plastic fluids, or Newtonian fluids depending on the nature of the viscosifying agents or gelling agents added subsequently to the base fluid containing these nano-scale weighting agents. The viscosifying agents or gelling agents may be conventional viscosifying agents or gelling agents well known to those of skill in the art or may be viscosifying agents or gelling agents taught in Leggett et al., or viscosifying agents or gelling agents taught herein.

In one aspect, the present invention also relates to viscosified, oil-based or hydrocarbon-based fluids and the use of said viscosified, oil-based or hydrocarbon-based fluids in hydraulic fracturing operations. A hydraulic fracturing fluid in accordance with one embodiment of the invention includes a hydrocarbon fluid, wherein the fluid is a viscous, Newtonian fluid. In another aspect, the present invention relates to the use of readily available oil-based or hydrocarbon-based fluids which may be converted into viscosified—Newtonian, Bingham-plastic, power-law, or yield-power-law—fluids for use in hydraulic fracturing of subterranean petroliferous formations. A hydraulic fracturing fluid in accordance with one embodiment of the invention includes a hydrocarbon fluid and a gelling agent, wherein the fluid is a power law fluid. A hydraulic fracturing fluid in accordance with another embodiment of the invention includes a hydrocarbon fluid; a gelling agent; and a rheological additive, wherein the fluid is a yield power law fluid. In one embodiment, exemplary yield power law insulating packer fluids of Leggett et al., could be employed to advantage as hydraulic fracturing fluids. In other embodiments, the fluids used as hydraulic fracturing could be power law or Newtonian fluids which are not in accordance with the teachings of Leggett et al.

In another aspect, the present invention relates to methods for preparing a hydraulic fracturing fluid. A method in accordance with one embodiment of the invention includes preparing a mixture of a hydrocarbon fluid and a gelling agent; and mixing the two without heating or with heating to a selected temperature. A method in accordance with another embodiment of the invention includes preparing a mixture of a hydrocarbon fluid, a gelling agent, and a rheological additive; heating the mixture to a selected temperature; and shearing the mixture. In another embodiment, the hydrocarbon fluid is a weighted hydrocarbon-based fluid where the weighting agent can include nano-scale-zinc oxide products.

In another aspect, the present invention relates to methods for injecting a hydraulic fracturing fluid into a petroliferous formation. A method in accordance with one embodiment of the invention includes preparing the hydraulic fracturing fluid that includes a hydrocarbon fluid and a viscosifying agent, wherein the hydraulic fracturing fluid is a Newtonian fluid; and pumping the viscosified fluid into one or more injection well(s). Another method in accordance with one embodiment of the invention includes preparing the hydraulic fracturing fluid that includes a hydrocarbon fluid and a gelling agent, wherein the hydraulic fracturing fluid is a power law fluid; and pumping the hydraulic fracturing fluid into one or more well(s) for purposes of hydraulically fracturing the formation. Yet another method in accordance with one embodiment of the invention includes preparing the hydraulic fracturing fluid that includes a hydrocarbon fluid, a gelling agent, and a rheological additive, wherein the hydraulic fracturing fluid is a yield power law fluid; and pumping the hydraulic fracturing fluid into one or more well(s) for purposes of hydraulically fracturing the formation. In another embodiment, the hydrocarbon fluid is a weighted hydrocarbon-based fluid where the weighting agent can include nano-scale weighting products such as nano-scale-zinc oxide products. There is a degree of interchangeability between the terms “viscosifying agent” and “gelling agent”; and a gelled fluid would also be a viscosified fluid; but a viscosified fluid might not also be considered a gelled fluid; in the common usage if one had a Newtonian viscosified fluid and wanted to add into it a gelling agent, it would be understood that the Newtonian viscosified fluid would be turned into power law or yield power law fluid. Similarly, in the common usage if one had a power law viscosified fluid and wanted to add into it a gelling agent, it would be understood that the power law viscosified fluid would be turned into yield power law fluid; and if one had a Bingham plastic viscosified fluid and wanted to add into it a gelling agent, it would be understood that the Bingham plastic viscosified fluid would be turned into yield power law fluid.

As per Leggett et al., gelled hydrocarbons have been successfully used as hydraulic fracturing fluids, as described in a number of patents and publications, such as U.S. Pat. Nos. 3,757,864 issued to Crawford et al., 4,104,173 issued to Gay et al., 4,200,539 issued to Burnham et al. and 4,507,213 issued to Daccord et al. These patents are incorporated by reference in their entireties. In fracturing fluids, high viscosity is important for suspending the proppants. On the other hand, it is undesirable because fracturing fluids need to be pumped very rapidly into the well and the fractures. In contrast, according to Leggett et al., minimization or elimination of fluid movement is highly desirable for packer fluids once they are emplaced in the annulus. Having a base fluid that is miscible with or nearly miscible with the hydrocarbons originally in place in the reservoir is a distinct aid in initiation of the flow back of the hydraulic fracturing fluid and then the seamless transition to the production of the hydrocarbons from the reservoir.

Similar to the teachings of Leggett et al. relating to packer fluids, the hydraulic fracturing fluids in accordance with embodiments of the present disclosure are weighted, gelled oil-based (hydrocarbon-based) fluids having Newtonian, power law, or yield power law (Herschel-Bulkley) characteristics. Yield power law fluids have complex non-Newtonian rheological behavior. The weighting of the fluid may be through conventional means or through any feasible self-suspending means, such as, for example, a dispersion of nano-scale particles which are suspended by Brownian motion of the particles in the fluid. Yield power law fluids have complex non-Newtonian rheological behavior. A yield power law fluid does not start to move until an applied stress (force) exceeds its yield stress. Thus, a yield power law hydraulic fracturing fluid will remain in place (i.e., is not prone to movement) once it is emplaced in the wellbore and optionally the vicinity thereof, such as, for example, in the fractures extending from said wellbore. This resistance to movement may improve the performance of the hydraulic fracturing fluid. On the other hand, yield power law fluids tend to have relatively low high-shear-rate viscosity, making them relatively easier to inject (place) and, given a pumping shear stress in excess of the yield stress, to displace. That is, yield power law fluids can be pumped with relative ease into wellbores and the vicinities thereof during emplacement, as long as the applied stress from pumping exceeds the yield stress. For a discussion of tools for analyzing yield power law fluids, see the article coauthored by the inventor, Horton, et al., “A New Yield Power Law Analysis Tool Improves Insulating Annular Fluid Design,” paper No. AADE-05NTCE-49, AADE 2005 National Technical Conference and Exhibit, Houston, Tex., Apr. 5-7, 2005, which is herein incorporated by reference.

As mentioned above and discussed in Leggett et al., gelled hydrocarbons have long been successfully used as hydraulic fracturing fluids. In fracturing fluids, the characteristic of high viscosity is important for suspending the proppants but high mobility is also needed for getting the proppant slurry down the well and out into the fracture. These somewhat contradictory objectives can be achieved by way of a shear-dependent viscosity, such as that characterized by the Power Law, equation 1:

τ=K·\dot{γ}ⁿ^{ₘ} (1)

where
τ is the shear stress (lb_{f}/100 ft²),
K is the consistency factor,
\dot{γ} is the shear rate (s⁻¹), and
nₘ is the flow behavior index.
   Hydraulic fracturing fluids are typically selected such that they exhibit a flow behavior indices in the 0.5 to 0.8 range and a suitable value of the consistency factor so that they will be sufficiently viscous at moderate shear rate to carry proppant efficiently and also sufficiently mobile at high shear rate to allow the proppant slurry to move readily down the well and out into the fracture. However, hydraulic fracturing fluids seldom encounter the low shear rate range that viscosified miscible enhanced oil recovery fluids (or the viscosified insulating packer fluids of Leggett et al.) experience most of the time. For these viscosified fluids, rheological behavior is needed that is different from the power law behavior, especially in the 0.3 to 0.003 sec⁻¹ shear rate range (see paper No. AADE-05-NTCE-49 by Horton, et al., mentioned above). For these hydraulic fracturing fluids (or the insulating packer fluids of Leggett et al.), what is needed in some applications is not only a somewhat lower flow behavior index (preferably in the 0.4 to 0.7 range), but also a relatively large value of the yield stress (also referred to as τ_{y}), in the range of 1 to 200 lb_{f}/100 ft² as given in the Yield Power Law Equation (also known as the Herschel-Bulkley Equation), which is as follows:

τ=τ_{y}+Kₘ·\dot{γ}ⁿ^{ₘ} (2)

where
τ is the shear stress as in Equation 1,
τ_{y} is the yield stress (lb_{f}/100 ft²),
Kₘ is the consistency factor,
\dot{γ} is the shear rate (s⁻¹), and
nₘ is the flow behavior index.
   The shear rate environment of working hydraulic fracturing fluids (or the insulating packer fluids of Leggett et al.) is such that, while the fluid is being emplaced or displaced, τ_{y} in the range of 1 to 200 lb_{f}/100 ft² is relatively unimportant compared with the other parameters given in Equation 2; but the converse is true for the majority of the lifetime of a working hydraulic fracturing fluid (or the insulating packer fluids of Leggett et al.)—here, the extended period of time between emplacement and displacement. This latter fact is the reason why a conventional hydraulic fracturing fluid is generally not best suited for use as a viscosified miscible injectant fluid (or as an insulating packer fluid per Leggett et al.).

In accordance with some embodiments of the invention, hydraulic fracturing fluids (much like the insulating packer fluids of Leggett et al.) may be based on conventional gelled hydrocarbons or optionally on conventional weighted hydrocarbons, but further include rheological additives to produce Newtonian, power law, or yield power law fluids and optionally may be based on unconventionally weighted hydrocarbons, such as, for example, those into which nano-scale metal salts are dispersed. Conventional gelled hydrocarbons may be obtained by introducing phosphoric acid esters and an aluminum (or ferric) compound into hydrocarbon base fluids. These gelled hydrocarbon fluids have a three-dimensional polymer element in the hydrocarbons. The three-dimensional polymer element causing the gelling is constituted by phosphoric acid esters bonded (complexed) with aluminum or ferric cations. The presence of long alkyl side chains on the phosphoric acid ester render these polymer elements soluble in the hydrocarbons. Optionally, the aluminum or ferric cations may be aluminum or ferric cations in chelated form (which chelation may convert the cationic species into neutral or anionic species). Optionally, the conventional weighted hydrocarbons may be replaced with hydrocarbons comprising self-suspended weighting agents and/or nanoscale weighting agents.

A hydraulic fracturing fluid in accordance with embodiments of the present disclosure comprises hydrocarbon base fluids, a weighting agent that may optionally be a self-suspending weighting agent, and a gelling agent that makes the gelled hydrocarbons behave like a power law fluid. A hydraulic fracturing fluid in accordance with embodiments of the invention (or the insulating packer fluids of Leggett et al.) comprises hydrocarbon base fluids, a weighting agent that may optionally be a self-suspending weighting agent, and a gelling agent and a rheological additive that makes the gelled hydrocarbons behave like a power law fluid. One of ordinary skill in the art would appreciate that various rheological additives may be used to impart a fluid with the desired power law or yield power law characteristics.

As identified in Leggett et al., suitable rheological additives in accordance with embodiments of the invention, for example, may include alkyl diamides, such as those having a general formula: R₁—HN—CO—(CH₂)ₙ—CO—NH—R₂, wherein n is an integer from 1 to 20, more preferably from 1 to 4, yet more preferably from 1 to 2, and R₁ is an alkyl groups having from 1 to 20 carbons, more preferably from 4 to 12 carbons, and yet more preferably from 5 to 8 carbons, and R₂ is hydrogen or an alkyl group having from 1 to 20 carbons, or more preferably is hydrogen or an alkyl group having from 1 to 4 carbons, wherein R₁ and R₂ may or may not be identical. Such alkyl diamides may be obtained, for example, from M-I L.L.C. (Houston, Tex.) under the trade name of VersaPac™.

The VersaPac™ product has been used as a thermally activated gelling agent, which generates viscosity and develops gel structure when sheared and heated to a temperature above 60° C. When the VersaPac™ product is fully activated, the gel structure remains stable even if the temperature drops below 60° C. However, when used at a temperature above its melting point (120° C.), the rheological effect gradually decreases.

The VersaPac™ product is activated by a combination of heat and shear. In the absence of shear and below the temperature of activation, the rheological effect of the VersaPac™ product is minimal because the particles do not swell. The gelling mechanism involves the swelling of the initial agglomerates and a gradual release of individual oligomer chains. The released oligomers then associate with other particulate material to produce the rheological effect. The build-up of this structure is thixotropic as it involves re-alignment of the initial structure to the most thermodynamically stable configuration. When totally activated, a type of micelle structure is formed involving the gelling agent and the other components in the system.

In accordance with some embodiments of the present disclosure, hydraulic fracturing fluids may be based on a hydrocarbon, a weighting agent that may optionally be a self-suspending weighting agent, and a hydrocarbon gelling agent wherein the gelling agent comprises poly-(ethylene-co-chloroethylene-co-[sodium chloroethylene-sulfonate]) (which is available, for example, as product XRP 032 from Eliokem, Inc., 1452 East Archwood Avenue, Akron, Ohio 44306).

In accordance with some embodiments of the invention, a hydraulic fracturing fluid comprises a rheological additive, as noted above, added to a hydrocarbon fluid that includes a weighting agent that may optionally be a self-suspending weighting agent; and one or more gelling agents, such as phosphoric acid esters in the presence of a ferric or aluminum compound. The hydrocarbons, for example, may be diesels, paraffin oils, crude oils, kerosene, or mixtures thereof. The weighting agent that may optionally be a self-suspending weighting agent may be an alkali metal, alkaline earth, or other metal oxide, or an alkali metal, alkaline earth, or other metal salt. The phosphoric acid esters may have same or different alkyl groups, having various lengths. In accordance with embodiments of the invention, the alkyl groups (i.e., the ester parts) of the phosphoric acid esters have two or more carbon atoms, and preferably at least one of the alkyl groups has 3 to 10 carbon atoms. The ferric or aluminum compounds may be organic or inorganic compounds, such as aluminum chloride, aluminum alkoxide, ferric chloride, organometallic complexes of aluminum or iron(III), amine carboxylic acid salts of aluminum or iron(III), etc.

As identified in Leggett et al., the phosphoric acid esters having a desired alkyl group may be prepared using phosphorous pentaoxide and triethyl phosphate (TEP) (or other similar phosphate triesters) in the presence of a trace amount of water:

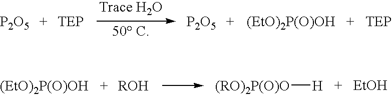

In the reactions shown above, the tri-ethyl phosphate ester (TEP) is partially hydrolyzed to produce a phosphoric acid diethyl ester. The phosphoric acid diethyl ester is then transesterified with a selected alcohol (ROH) to regenerate a phosphoric acid dialkyl ester having at least one and often two ester alkyl groups derived from the ROH.

As also taught in Leggett et al., the alcohol (ROH), i.e., the length of the alkyl chain R, may be selected to provide the desired hydrophobicity. In accordance with embodiments of the invention, the alcohols (ROH) have 2 or more carbons (i.e., ethanol or higher), and preferably, 2 to 10 carbons, which may be straight or branched chains. The phosphoric acid dialkyl esters having the alkyl chain of 2-10 carbons long may be obtained from M-I L.L.C. (Houston, Tex.) under the trade name of ECF-976. In accordance with some embodiments of the present invention, the R group may include aromatic or other functional groups, as long as it can still provide proper solubility in the hydrocarbon base fluids.

One of ordinary skill in the art would appreciate that various other reactions may be used to prepare the desired phosphoric esters without departing from the scope of the invention. For example, as noted in Leggett et al., phosphoric acid esters may be prepared using phosphorous hemipentaoxide (or phosphorous pentaoxide P₂O₅) and a mixture of long chain alcohols, as disclosed in U.S. Pat. No. 4,507,213:

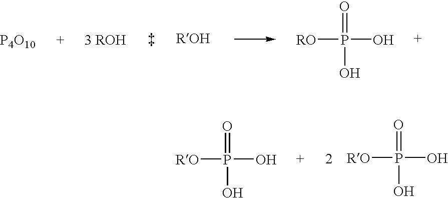

This reaction produces a mixture of phosphoric acid monoesters and diesters. Furthermore, while the above reaction is shown with two different alcohols, the same reaction may also be performed with one kind of alcohol to simplify the product composition. Note that embodiments of the invention may use a mixture of phosphoric acid esters, i.e., not limited to the use of a pure phosphoric acid ester. As used herein, “phosphoric acid esters” include mono acid di-esters and di-acid monoesters. Furthermore, instead of or in addition to phosphoric esters, embodiments of the present invention may also use phosphonic acid esters, as disclosed in U.S. Pat. No. 6,511,944 issued to Taylor et al. A phosphonic acid ester has an alkyl group directly bonded to the phosphorous atom and includes one acid and one ester group. One of ordinary skill in the art would also recognize that other types of gelling agents may be used including anionic polymers, such as poly-(ethylene-co-chloroethylene-co-[sodium chloroethylene-sulfonate]), or emulsions formed from an emulsifier and a water-miscible internal phase. Depending on the rheological properties of a fluid formed with these gelling agents, and whether gelling agent itself imparts a fluid with the desired yield power law characteristics, rheological additives may optionally be included.

A hydraulic fracturing fluid in accordance with one embodiment of the invention, (like the insulating packer fluids of Leggett et al.) may be prepared as follows: a base fluid of hydrocarbons, a gelling agent comprising a phosphoric acid ester (e.g., ECF-976 product from M-I L.L.C.) or a phosphonic acid ester complexing with a multivalent metal ion (e.g., ferric or aluminum ion, or ECF-977 product from M-I L.L.C.), and a rheological additive (e.g., VersaPac™ alkyl diamides) are mixed in a blender (to shear the mixture) at an elevated temperature (e.g., 180° F., about 80° C.) to facilitate the dissolution or swelling of the dialkyl diamide. The base fluid may comprise, for example, diesels, a mixture of diesels and paraffin oil (e.g., 85%: 15% mixture), mineral oil, IO 16/18 base fluid, Saraline 185V™ synthetic oil, or Safe-Solv OM™ (additive characterized as a combination of powerful, non-aromatic hydrocarbon and natural terpene solvents and surfactants with exceptional oil and grease solvent properties from M-I L.L.C.) and Safe-T-Pickle™ (additive characterized as a non-aromatic, high-flashpoint pipe dope solvent from M-I L.L.C.), EDC 99-DW™ (drilling fluid from TOTAL Special Fluids), or PureDrill HT-40™ (drilling mud base fluid from PetroCanada). To these hydrocarbon base fluids may optionally be added a weighting agent that may optionally be a self-suspending weighting agent. In addition, a hydraulic fracturing fluid in accordance with some embodiments of the invention may further comprise other components that are commonly used in such fluids, such as emulsifiers and inorganic salts (e.g., calcium chloride, calcium bromide, etc.). Examples of emulsifiers include those sold under the trade names of VersaMul™ and VersaCoat™ by M-I L.L.C. For example, a viscosified fluid of the invention may comprise a blend of diesel with about 3-9 ppb (pounds per barrel) Ecotrol RD™ (an oil soluble fluid control additive polymer from M-I L.L.C.) and about 3-9 ppb of the VersaPac™ product. One of ordinary skill in the art would appreciate that the gelling agents and the rheological additives may be added in a suitable amount for the desired properties.

As also taught in Leggett et al., since the VersaPac™ product (or similar alkyl diamides) is barely soluble in oil-based fluids, an alternative method of preparation involves first preparing a slurry (e.g., an 1:1 slurry) of VersaPac™ product in an appropriate solvent (e.g., propylene glycol, polypropylene glycol, or other similar solvents). This preparation may be performed with a blender at a lower temperature (e.g., 135° F., about 58° C.). This slurry is then added to the oil-based fluids and the gelling agents. Alternatively, instead of first preparing a slurry of VersaPac™ product in said appropriate solvent, the VersaPac™ product and then said appropriate solvent may simply be added to the oil-based fluids and the preparation may then be performed with a blender at a lower temperature (e.g., 135° F., about 58° C.). Then the gelling agent comprising a phosphoric acid ester (e.g., ECF-976 from M-I L.L.C.) or a phosphonic acid ester complexing with a multivalent metal ion (e.g., ferric or aluminum ion, or ECF-977 from M-I L.L.C.), is subsequently added to this mixture. And, as yet another alternative, instead of first preparing a slurry of VersaPac™ product in said appropriate solvent, the said appropriate solvent and then the VersaPac™ product may simply be added to the oil-based fluids and the preparation may then be performed with a blender at a lower temperature (e.g., 135° F., about 58° C.). Then the gelling agent comprising a phosphoric acid ester (e.g., ECF-976 from M-I L.L.C.) or a phosphonic acid ester complexing with a multivalent metal ion (e.g., ferric or aluminum ion, or ECF-977 from M-I L.L.C.), is subsequently added to this mixture. Of these three possible alternatives, the latter is slightly preferred over the other two; and all three of these alternatives (because they involve heating and shearing to only 135° F.) are slightly preferred over the alternative of adding all components at once and subjecting the mixture to heating and shearing to 180° F. In addition, it will be obvious to one skilled in the art that other methods may also be used to effect the same result.

In another embodiment of the present disclosure, a yield power law fluid may be prepared as follows: a base fluid of hydrocarbons a weighting agent that may optionally be a self-suspending weighting agent, and a gelling agent comprising poly-(ethylene-co-chloroethylene-co-[sodium chloroethylenesulfonate]) (which is available, for example, as product XRP 032 from Eliokem, Inc., 1452 East Archwood Avenue, Akron, Ohio 44306) may be mixed in a low shear blender at a moderately elevated temperature (e.g., 122 to 140° F., about 50 to 60° C.) to facilitate the dissolution or swelling of the copolymer. Optionally, a dialkyl diamide and/or a phosphoric acid ester (e.g., ECF 976 from M-I L.L.C.) or a phosphonic acid ester complexing with a multivalent metal ion (e.g., ferric or aluminum ion, or ECF 977 from M-I L.L.C.) may be added. The base fluid may comprise, for example, diesels, a mixture of diesels and paraffin oil (e.g., 85%: 15% mixture), mineral oil, 10 16-18™, Saraline 185V™, or Safe-Solv OM™, and Safe-T-Pickle™ from M-I L.L.C., EDC99 DW™ from TOTAL, or PureDrill HT-40™ from PetroCanada. To these hydrocarbon base fluids may optionally be added a weighting agent that may optionally be a self-suspending weighting agent. In addition, a hydraulic fracturing fluid in accordance with some embodiments of the present disclosure may further comprise other components that are commonly used in such fluids, such as emulsifiers and inorganic salts (e.g., calcium chloride, calcium bromide, etc.). One of ordinary skill in the art would appreciate that the gelling agents and the rheological additives may be added in a suitable amount for the desired properties.

In yet another embodiment of the present disclosure, a yield power law fluid may be prepared as follows: a base fluid of hydrocarbons and a gelling agent comprising a combination of an emulsifier (which is available, for example, as product Surfazol 1000 from The Lubrizol Corp., 29400 Lakeland Blvd., Wickliffe, Ohio 44092) and a water-miscible internal phase are mixed in a low-shear blender at a moderately elevated temperature (e.g., 122 to 140° F., about 50 to 60° C.) to facilitate the initiation of emulsification, which is continued by hot-rolling the mixture at 150° F. (about 66° C.) overnight.

The water-miscible internal phase may be supplied from a dense brine such as 19.2 ppg zinc-calcium bromide brine in a ratio such that the volumetric ratio of external to internal phase is maintained around 88.8:11.2 to keep the density of the product yield power law fluid above about 8.60 lbₘ/gal.

In yet another embodiment, the water-miscible internal phase may be supplied from a dense water-miscible but water-free fluid such as a solution of zinc bromide and calcium bromide in ethylene glycol, propylene glycol, diethylene glycol, or triethylene glycol. In a further embodiment, the water miscible internal phase may be supplied from a mixture of an ordinary dense brine with a dense water-miscible but water-free fluid such as a solution of zinc bromide and calcium bromide in ethylene glycol, propylene glycol, diethylene glycol, or triethylene glycol. In yet another embodiment, the water-miscible internal phase may be supplied from a mixture of an ordinary dense brine with a dense water-miscible but water-free fluid such as a solution of calcium bromide in ethylene glycol, propylene glycol, diethylene glycol, or triethylene glycol.

Optionally a dialkyl diamide may be added and/or a phosphoric acid ester (e.g., ECF 976 from M-I L.L.C.) or a phosphonic acid ester complexing with a multivalent metal ion (e.g., ferric or aluminum ion, or ECF 977 from M-I L.L.C.) may be added. The base fluid may comprise, for example, diesels, a mixture of diesels and paraffin oil (e.g., 85%: 15% mixture), mineral oil, IO 16-18™, Saraline 185V™, or Safe-Solv OM™, and Safe-T-Pickle™ from M-I L.L.C., EDC99 DW™ from TOTAL, or PureDrill HT-40™ from PetroCanada. To these hydrocarbon base fluids may optionally be added a weighting agent that may optionally be a self-suspending weighting agent. In addition, a hydraulic fracturing fluid in accordance with some embodiments of the present disclosure may further comprise other components that are commonly used in such fluids, such as emulsifiers and inorganic salts (e.g., calcium chloride, calcium bromide, etc.). One of ordinary skill in the art would appreciate that the gelling agents and the rheological additives may be added in a suitable amount for the desired properties.

In yet another embodiment of the present invention, a weighted, oil-based fluid (which may be a hydraulic fracturing fluid or not) optionally wherein the fluids comprise nano-scale particles or otherwise self-suspending particles, may be used as a breaker fluid for a conventional hydraulic fracturing fluid or for a fluid in accordance with anyone of the previously discussed embodiments of the present invention. The weighting agents for such weighted, oil-based fluids (which may be hydraulic fracturing fluids or not) may be alkali metal, or alkaline earth metal salts, or transition metal salts, such as, for example, magnesium oxide or anyone of the iron oxides. An allied embodiment of the present invention relates to methods for preparing said breaker fluid for a hydraulic fracturing fluid. A method in accordance with one embodiment of the invention includes preparing a mixture of a hydrocarbon fluid, a weighting agent that may optionally be a self-suspending weighting agent, comprising alkali metal, or alkaline earth metal salts, or transition metal salts, such as, for example, magnesium oxide or any one of the iron oxides, optionally adding a gelling agent, and optionally adding a rheological additive; optionally heating the mixture to a selected temperature; and optionally shearing the mixture.

In another embodiment, the present invention relates to methods for emplacing into a wellbore and optionally the vicinity thereof, a weighted, oil based fluid (which may be a hydraulic fracturing fluid or not) in order to utilize said fluid as a breaker for a hydraulic fracturing fluid. A method in accordance with one embodiment of the invention includes preparing the annular fluid that includes a hydrocarbon fluid, a weighting agent that may optionally be a self suspending weighting agent, a gelling agent, and a rheological additive, wherein the hydraulic fracturing fluid is a Newtonian, power law, or yield power law fluid; and pumping the hydraulic fracturing fluid into a wellbore and optionally the vicinity thereof, such as, for example, in the fractures extending from said wellbore. The weighting agents for such weighted, oil-based breaker fluids (which may be hydraulic fracturing fluids or not) may be alkali metal, or alkaline earth metal salts, or transition metal salts, such as, for example, magnesium oxide or anyone of the iron oxides.

When gelled hydrocarbon fracturing fluids (power-law fluids) or yield-power-law fluids are injected in accordance with the present invention, it may be desirable to practice alternative embodiments of the present invention wherein a mild acid such as, for example, acetic acid or the like, or an acid gas such as, for example, CO₂ or the like is injected prior to the miscible flooding. Some subterranean petroliferous formations include naturally occurring alkalinity which might adversely affect the rheological properties of said gelled hydrocarbon fracturing fluids or yield-power-law fluids; and the pre-injection of such an acid or acid gas will sacrifice the relatively inexpensive acid or acid gas to the neutralization of said alkalinity.

In one embodiment of the present invention, subsequent steps are optionally performed such as, for example, employing a viscosity breaker to the emplaced hydraulic fracture fluid so that the larger part of the emplaced hydraulic fracture fluid may also be recovered from the proppant pack and from the formation. For gelled hydrocarbon fracturing fluids or yield-power-law fluids injected in accordance with the present invention, examples of highly mobile breakers include NH₃ and the like.

As also in Leggett et al., advantages of the invention may include one or more of the following: Hydraulic fracturing fluids in accordance with embodiments disclosed herein have Newtonian, power law, or yield power law rheological characteristics such that they are not prone to movement once they are emplaced in a wellbore and optionally the vicinity thereof, such as, for example, in the fractures extending from said wellbore. Minimization of movements in these fluids and increase in their density relative to the un-weighted base fluids improves their performance as carriers of hydraulic fracturing fluids proppants and in other manners. These yield power law fluids can still be pumped during emplacement of the hydraulic fracturing fluids. The base fluids may be selected from various hydrocarbons, having densities that are greater than the density of the base fluid, such that they will suit particular applications. The present invention teaches additionally a novel class of breaker fluids for conventional and novel hydraulic fracturing fluids.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A hydraulic fracturing fluid for injection into a subterranean petroliferous formation for hydraulic fracturing of said formation comprising:
a weighted hydrocarbon-based fluid comprising a nano-scale weighting agent dispersed in a hydrocarbon-based fluid, and
at least one additive selected from the group consisting of viscosifying agents, gelling agents and rheological agents,
wherein said hydraulic fracturing fluid has fluid behavior characteristics selected from the group consisting of yield power law fluids, power law fluids, Bingham-plastic fluids and Newtonian fluids.

2. The hydraulic fracturing fluid of claim 1, wherein said nano-scale weighting agent comprises at least one of barium sulfate, barium carbonate, zinc oxide, zinc nitride, magnesium oxide, or iron oxide.

3. The hydraulic fracturing fluid of claim 1, wherein said nano-scale weighting agent comprises a nano-scale-zinc-oxide.

4. The hydraulic fracturing fluid of claim 1, wherein said gelling agent comprises a multivalent metal ion and at least one ester selected from the group consisting of a phosphoric acid ester and a phosphonic acid ester.

5. The hydraulic fracturing fluid of claim 4, wherein said multivalent metal ion is at least one selected from the group consisting of a ferric ion, an aluminum ion, a chelated ferric ion and a chelated aluminum ion.

6. The hydraulic fracturing fluid of claim 1, wherein said rheological agent is an alkyl diamide having a formula: R₁—HN—CO—(CH₂)ₙ—CO—NH—R₂, wherein n is an integer from 1 to 20, R₁ is an alkyl groups having from 1 to 20 carbons, and R₂ is hydrogen or an alkyl group having from 1 to 20 carbons.

7. The hydraulic fracturing fluid of claim 1, wherein said rheological agent is present at a concentration of 3-13 pounds per barrel.

8. The hydraulic fracturing fluid of claim 1, further comprising a solvent for said rheological agent.

9. The hydraulic fracturing fluid of claim 1, wherein said hydrocarbon-based fluid comprises at least one selected from diesel, a mixture of diesels and paraffin oil, mineral oil, and isomerized olefins.

10. The hydraulic fracturing fluid of claim 1, wherein said at least one additive comprises a viscosifying agent.

11. The hydraulic fracturing fluid of claim 1, wherein said at least one additive comprises a gelling agent.

12. The hydraulic fracturing fluid of claim 1, wherein said at least one additive comprises a gelling agent and a rheological agent.

13. The hydraulic fracturing fluid of claim 1, wherein said at least one additive comprises a gelling agent, a rheological agent and a solvent for said rheological agent.

14. A method for preparing a hydraulic fracturing for injection into a subterranean petroliferous formation for hydraulic fracturing of said formation comprising the steps of:
preparing a mixture of a weighted hydrocarbon-based fluid comprising a nano-scale weighting agent dispersed in a hydrocarbon-based fluid and at least one additive selected from the group consisting of viscosifying agents, gelling agents and rheological agents;
optionally heating said mixture to a selected temperature; and
optionally shearing said mixture,
wherein said mixture has fluid behavior characteristics selected from the group consisting of yield power law fluids, power law fluids, Bingham-plastic fluids and Newtonian fluids.

15. A method for hydraulic fracturing of a subterranean petroliferous formation comprising the steps of:
preparing a hydraulic fracturing fluid comprising: a mixture of (a) a weighted hydrocarbon-based fluid comprising a nano-scale weighting agent dispersed in said hydrocarbon-based fluid, and (b) at least one additive selected from the group consisting of viscosifying agents, gelling agents and rheological agents;
optionally adding proppant to said hydraulic fracturing fluid; and
pumping said fluid or fluid and proppant mixture from the surface into said subterranean petroliferous formation;
wherein said hydraulic fracturing fluid exhibits fluid behavior characteristics selected from the group consisting of yield power law fluid characteristics, power law fluid characteristics, Bingham-plastic fluid characteristics, and Newtonian fluid characteristics.

16. The method of claim 15, wherein said nano-scale weighting agent comprises at least one of barium sulfate, barium carbonate, zinc oxide, zinc nitride, magnesium oxide, or iron oxide.

17. The method of claim 15, wherein said nano-scale weighting agent comprises a nano-scale-zinc-oxide.

18. The method of claim 15, wherein said gelling agent comprises a multivalent metal ion and at least one ester selected from the group consisting of a phosphoric acid ester and a phosphonic acid ester.

19. The method of claim 18, wherein said multivalent metal ion is at least one selected from the group consisting of a ferric ion, an aluminum ion, a chelated ferric ion and a chelated aluminum ion.

20. The method of claim 15, wherein said rheological additive is an alkyl diamide having a formula: R₁—HN—CO—(CH₂)ₙ—CO—NH—R₂, wherein n is an integer from 1 to 20, R₁ is an alkyl groups having from 1 to 20 carbons, and R₂ is hydrogen or an alkyl group having from 1 to 20 carbons.

21. The method of claim 15, wherein said rheological additive is present at a concentration of 3-13 pounds per barrel.

22. The method of claim 15, further comprising a solvent for said rheological agent.

23. The method of claim 15, wherein said hydrocarbon fluid comprises at least one selected from diesel, a mixture of diesels and paraffin oil, mineral oil, and isomerized olefins.

24. The method of claim 15, wherein said at least one additive comprises a viscosifying agent.

25. The method of claim 15, wherein said at least one additive comprises a gelling agent.

26. The method of claim 15, wherein said at least one additive comprises a gelling agent and a rheological agent.

27. The method of claim 15, wherein said at least one additive comprises a gelling agent, a rheological agent and a solvent for said rheological agent.

28. The method of claim 15 further comprising the step of subsequently recovering some of said hydraulic fracturing fluid back to the surface from said subterranean petroliferous formation.

29. The method of claim 15 further comprising the step of subsequently recovering some of said hydraulic fracturing fluid by (a) applying a viscosity breaker proximate said viscosified miscible enhanced oil recovery fluid in said subterranean petroliferous formation and (b) flowing said viscosity-broken fluid back to the surface.

30. The method of claim 15 further comprising the initial step of determining whether alkalinity conditions exist in said petroliferous formation that could be damaging to said hydraulic fracturing fluid, and if so, prior to the injection of said miscible viscosified enhanced oil recovery fluid, injecting a mild acid or acid gas to neutralize said alkalinity.

31. An oil-based breaker fluid comprising:
a weighted hydrocarbon-based fluid comprising a weighting agent dispersed in a hydrocarbon-based fluid,
wherein said breaker fluid has fluid behavior characteristics selected from the group consisting of yield power law fluids, power law fluids, Bingham-plastic fluids and Newtonian fluids.

32. The breaker fluid of claim 31, wherein said weighting agent comprises nano-scale particles or self-suspending particles.

33. The breaker fluid of claim 31, wherein said nano-scale weighting agent comprises a nano-scale-zinc-oxide.

34. The breaker fluid of claim 32 wherein said nano-scale particles or self-suspending particles are selected from the group consisting of alkali metals, or alkaline earth metal salts, or transition metal salts.

35. The breaker fluid of claim 32 wherein said nano-scale particles or self-suspending particles are selected from the group consisting of barium sulfate, barium carbonate, zinc oxide, zinc nitride, magnesium oxide, or iron oxide.

36. The breaker fluid of claim 31 further comprising at least one additive selected from the group consisting of viscosifying agents, gelling agents and rheological agents.
